(19) United States
(12) Patent Application Publication
(10) Pub. No.: US 2011/0246311 A1
(43) Pub. Date: Oct. 6, 2011

(54) Advertisement System and Advertisement Broadcasting Method

(76) Inventor: Ting-Yu Chang, Taipei Hsien (TW)

(21) Appl. No.: 12/940,044

(22) Filed: Nov. 5, 2010

(30) Foreign Application Priority Data
Mar. 31, 2010 (TW) 099109887

(51) Int. Cl. G06Q 30/00

(52) U.S. Cl. 705/14.72

(57) ABSTRACT

An advertisement system for broadcasting an advertisement includes a data generating device for generating the advertisement, a display device coupled to the data generating device for outputting the advertisement, an infrared detector for detecting variations of infrared signals within a specific range from the display device, to generate a detection result, and a control unit for control the data generating device according to the detection result.

### BACKGROUND OF THE INVENTION

1. Field of the Invention

The present invention relates to an advertisement system and advertisement broadcasting method, and more particularly, to an advertisement system and advertisement broadcasting method capable of providing lively and interactive effects and enhancing advertisement benefit.

2. Description of the Prior Art

“Advertisement” is an action of delivering information and has been derived into different forms as technology progresses. However, an advertisement can only be read or listened passively. Hence, how to improve interactions of an advertisement and further enhance the advertisement benefit becomes one of the targets in the industry.

### SUMMARY OF THE INVENTION

It is therefore an objective of the claimed invention to provide an advertisement system and advertisement broadcasting method.

The present invention discloses an advertisement system for broadcasting an advertisement, which comprises a data generating device for generating the advertisement, a display device coupled to the data generating device for outputting the advertisement, an infrared detector for detecting variations of infrared signals within a specific range from the display device, to generate a detection result, and a control unit for controlling the data generating device according to the detection result.

The present invention further discloses a method for broadcasting an advertisement, which comprises outputting an advertisement via a display device, detecting variations of infrared signals within a specific range, to generate a detection result, and adjusting the advertisement shown by the display device according to the detection result.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of an advertisement system according to an embodiment of the present invention.

FIG. 2 is a schematic diagram of an advertisement broadcasting process according to the embodiment of the present invention.

### DETAILED DESCRIPTION

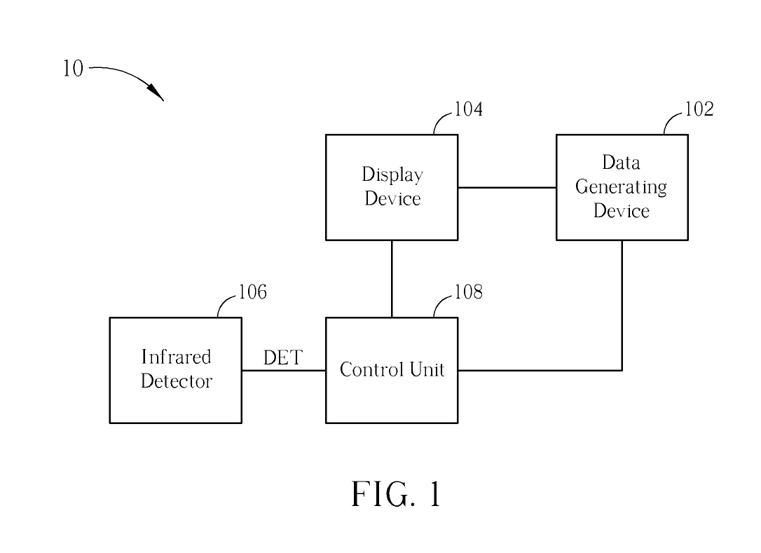

Please refer to FIG. 1, which is a schematic diagram of an advertisement system 10 according to an embodiment of the present invention. The advertisement system 10 broadcasts an advertisement via an interactive method and comprises a data generating device 102, a display device 104, an infrared detector 106, and a control unit 108. The data generating device 102 is utilized for generating the advertisement and outputting the advertisement to the display device 104, to show the advertisement via the display device 104. The infrared detector 106 is utilized for detecting variations of infrared signals within a specific range from the display device 104, to generate a detection result DET. The control unit 108 controls the data generating device 102 according to the detection result DET and in another embodiment, the control unit 108 further controls the display device 104.

In short, the advertisement system 10 controls operations of the display device 104 according to the detection result DET within the specific range from the display device 104, so as to generate an interactive advertisement effect and attract consumer's attention. For example, when the infrared detector 106 does not detect variations of infrared signals resulted from a human, the control unit 108 indicates the data generating device 102 to output a common advertisement, such as an introduction of products, an introduction of scenic sites, etc., according to the detection result DET. When the infrared detector 106 detects variations of infrared signals resulted from a human within the specific range from the display device 104, the control unit 108 indicates the data generating device 102 to add a predetermined message, such as “Welcome”, “Instant weather report”, “New special offers”, etc. Under such a situation, information shown in the display device 104 is no more rigid and inflexible, but lively and interactive for consumers. Hence, the advertisement benefit is enhanced.

Note that, the advertisement system 10 shown in FIG. 1 is an embodiment of the present invention, and those skilled in the art can make modifications or alternations according to system requirements. For example, the data generating device 102 can be a data storage device, such as a memory card, a hard disk, etc., or a computer system capable of processing data. If the data generating device 102 is implemented by a computer system, a control mechanism can further be added. For example, if the display device 104 is implemented by a touch display device, the display device 104 can control the data generating device 102 as well as showing the advertisement. Using a touch display device to control a computer system is well known for those skilled in the art, and is not an essential point of the present invention; thus, details are not further narrated hereinafter.

In addition, the predetermined message generated by the data generating device 102 according to the indication of the control unit 108 is not limited to images of text, pictures, etc., and can be other types according to system requirements or designs. For example, if the display device 104 includes a speaker, the predetermined message generated by the data generating device 102 can include audio signals.

Moreover, the control unit 108 can control the data generating device 102, or further control the display device 104. For example, if the display device 104 is a liquid crystal display (LCD), the control unit 108 can reduce a brightness of backlights according to the detection result DET when the infrared detector 106 does not detect any human, so as to save power consumption.

Furthermore, the infrared detector 106 detects infrared signals via an infrared detection method, and is preferably a pyroelectric infrared radial sensor but not restricted herein. If the infrared detector 106 can further detect a distance between a human and the display device 104, the control unit 108 can also control the data generating device 102 or the display device 104 in different methods according to the detected distance. For example, when the distance is less than a predefined value, the control unit 108 controls the data generating device 102 to output data with more complexity or controls the display device 104 to show the advertisement in a higher definition.

Hence, as mentioned in the above, the advertisement system 10 adjusts the advertisement according to variations of infrared signals within the specific range, so as to provide a lively and interactive platform and enhance the advertisement benefit. Note that, the embodiment mentioned in the above illustrates the spirit of the present invention, and those skilled in the art can make proper modifications or alternations according to different applications. For example, if the advertisement system 10 is applied to introduce scenic spots and the display device 104 is a touch display device, the control unit 108 can automatically start introduction of the scenic spots when the infrared detector 106 detects a human approaches, and control the display device 104 to show scenery pictures when nobody approaches. If the advertisement system 10 is applied to a restaurant, the display device 104 can be designed to broadcast a voice “Welcome” and show clickable items like “Restaurant Introduction” or “Meal Inquiry” when a guest approaches. If the advertisement system 10 is applied to a store, the display device 104 can be designed to show clickable items such as “Product Introduction” and “Specials Inquiry” when a guest approaches. Under such a situation, the advertisement system 10 can provide lively and interactive advertisement effects, to enhance the advertisement benefit.

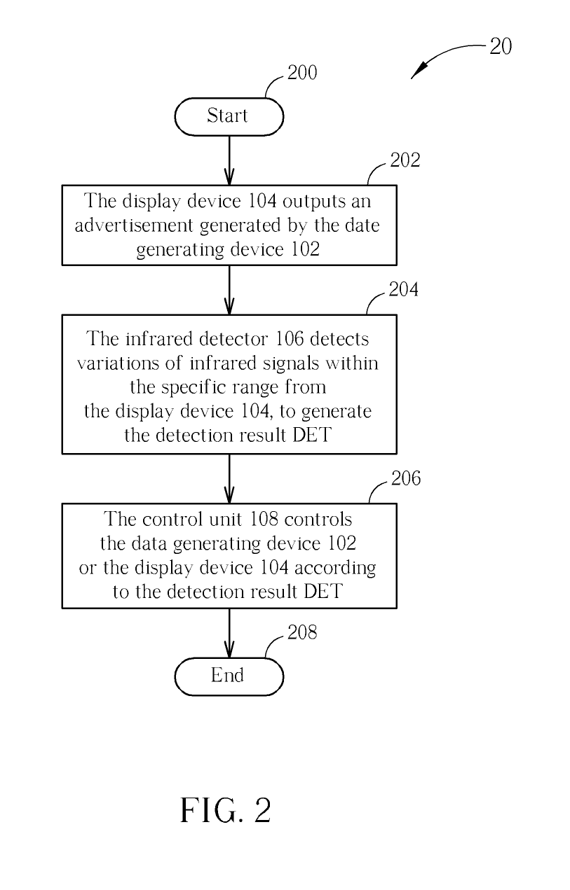

Operations of the advertisement system 10 can be concluded into an advertisement broadcasting process 20, as shown in FIG. 2. The advertisement broadcasting process 20 includes the following steps:

Step 200: Start.

Step 202: The display device 104 outputs an advertisement generated by the date generating device 102.

Step 204: The infrared detector 106 detects variations of infrared signals within the specific range from the display device 104, to generate the detection result DET.

Step 206: The control unit 108 controls the data generating device 102 or the display device 104 according to the detection result DET.

Step 208: End.

Details of the advertisement broadcasting process 20 are mentioned in the above, and thus are not narrated herein.

In the prior art, an advertisement can only be read or listened passively, and can not efficiently attract the consumer's attention. In comparison, the present invention can adjust the advertisement according to the distance between a consumer and the display device, and thus provide the lively and interactive advertisement effects, to enhance the advertisement benefit.

Those skilled in the art will readily observe that numerous modifications and alterations of the device and method may be made while retaining the teachings of the invention.

What is claimed is:

1. An advertisement system for broadcasting an advertisement, comprising:
a data generating device, for generating the advertisement;
a display device, coupled to the data generating device, for outputting the advertisement;
an infrared detector, for detecting variations of infrared signals within a specific range from the display device, to generate a detection result; and
a control unit, for controlling the data generating device according to the detection result.

2. The advertisement system of claim 1, wherein when the detection result indicates that a human is within the specific range, the control unit controls the data generating device to add a predetermined message into the advertisement.

3. The advertisement system of claim 1, wherein the control unit is further utilized for controlling the display device according to the detection result.

4. The advertisement system of claim 1, wherein the data generating device is a computer.

5. The advertisement system of claim 1, wherein the display device is a touch display device capable of controlling the data generating device.

6. The advertisement system of claim 1, wherein the infrared detector is a pyroelectric infrared radial sensor.

7. The advertisement system of claim 1, wherein the control unit is utilized for determining a distance between a human within the specific range and the display device according to the detection result, and controls the data generating device according to the distance.

8. The advertisement system of claim 7, wherein when the distance between the human and the display device is smaller than a default value, the control unit is utilized for controlling the data generating device to adjust the advertisement.

9. The advertisement system of claim 7, wherein when the distance between the human and the display device is greater than a default value, the control unit is utilized for adjusting a brightness of the display device.

10. A method for broadcasting an advertisement, comprising:
outputting an advertisement via a display device;
detecting variations of infrared signals within a specific range, to generate a detection result; and
adjusting the advertisement shown by the display device according to the detection result.

11. The advertisement broadcasting method of claim 10, wherein the step of adjusting the advertisement shown by the display device according to the detection result is adjusting the advertisement to add a predetermined message into the advertisement when the detection result indicates that a human is within the specific range.

12. The advertisement broadcasting method of claim 10, further comprising controlling operations of the display device according to the detection result.

13. The advertisement broadcasting method of claim 10, wherein the step of adjusting the advertisement shown by the display device according to the detection result is determining a distance between a human within the specific range and the display device according to the detection result, and controlling the data generating device according to the distance.

14. The advertisement broadcasting method of claim 13, wherein the step of adjusting the advertisement shown by the display device according to the detection result is controlling the data generating device to adjust the advertisement when the distance between the human and the display device is smaller than a default value.

15. The advertisement broadcasting method of claim 13, wherein the step of adjusting the advertisement shown by the display device according to the detection result further comprises adjusting a brightness of the display device when the distance between the human and the display device is greater than a default value.
